(19) United States
(12) Patent Application Publication
(10) Pub. No.: US 2022/0179892 A1
(43) Pub. Date: Jun. 9, 2022

(54) METHODS, SYSTEMS AND COMPUTER PROGRAM PRODUCTS FOR IMPLEMENTING NEURAL NETWORK BASED OPTIMIZATION OF DATABASE SEARCH FUNCTIONALITY

(71) Applicant: INCYZR PTY. LTD., East Lindfield, NSW (AU)

(72) Inventors: Roger Kermode, East Lindfield, NSW (AU); Archie Reed, Chatswood West, NSW (AU)

(21) Appl. No.: 17/601,608

(22) PCT Filed: Apr. 10, 2020
(86) PCT No.: PCT/IB2020/053432

§ 371 Date: Oct. 5, 2021

Related U.S. Application Data
(60) Provisional application No. 62/833,075, filed on Apr. 12, 2019.

(51) Int. Cl. G06F 16/33; G06F 16/332; G06F 40/284; G06F 40/295; G06F 40/30; G06N 3/04

(52) U.S. Cl. CPC G06F 16/3347; G06F 16/3329; G06N 3/0454; G06F 40/295; G06F 40/30; G06F 40/284

(57) ABSTRACT

The invention provides methods, systems and computer programs for optimizing database search functionality. In an embodiment, the invention comprises (i) receiving at least one sequence of words, (ii) identifying within the received sequence of words, one or more strings, based on string attributes, (iii) identifying a class corresponding to each identified string, (iv) generating a tokenized sequence of words by substituting the detected one or more strings with corresponding class descriptor tokens associated with an identified class for such string, (v) generating word embedding vector representations corresponding to an individual word within the generated tokenized sequence of words, (vi) generating a neural network corresponding to the tokenized sequence of words, and (vii) recording an association between the selected sequence of words and the generated neural network or the vector representation of the tokenized sequence of words.

### CROSS-REFERENCE TO RELATED APPLICATIONS

This application is a National Stage Application under 35 U.S.C. § 371 of PCT Application No. PCT/IB2020/053432, filed Apr. 10, 2020, which claims priority from and the benefit of U.S. Provisional Patent Application No. 62/833,075 filed Apr. 12, 2019, which are hereby incorporated by reference in their respective entireties.

### FIELD OF THE INVENTION

The present invention relates to the domain of natural language understanding systems. In particular, the invention provides methods, systems and computer program products for optimizing matching functionality in natural language understanding systems through implementation of neural networks and word embedding.

### BACKGROUND

Natural language understanding involves use of computer implemented systems to understand input received in the form of sentences in text or speech format, and to convert the received input into machine data models, including interpreted data, semantic analysis, interpretable instructions, or queries. Natural language understanding systems comprise processor implemented systems configured to enable matching of data, information or queries received by way of user input/search term(s) against a set of documents or data records for identifying documents or data records that are relevant to the received user input/search term(s). Such natural language understanding systems have multiple functional end uses—including by way of example, implantation within search engines for enabling users to submit a natural language query to the search engine instead of only keywords connected by Boolean operators.

It has typically been found that while matching engines within existing natural language understanding systems perform well in identifying documents that contain terms that are identical to, explicitly mapped or synonymous with input search terms, the existing state of art has been found to be less effective in identifying documents that are contextually, conceptually or semantically similar to user input terms/search term(s)—unless such contextually similar documents themselves include terms that are identical or synonymous with the user input terms/search term(s).

Therefore, there is a need for optimized natural language understanding systems and methods that improve matching and identification of results relevant to user input terms/search term(s).

### SUMMARY

The invention provides methods, systems and computer program products for optimizing matching functionality in natural language understanding systems through implementation of neural networks and word embedding.

In an embodiment, the invention provides a method for implementing neural network based optimization of database search functionality. The method comprises the steps of (i) receiving text data comprising a set of sequences of words, wherein one or more sequences of words within the received text data is intended to be added to a searchable database, (ii) implementing, for each of the one or more selected sequences of words within the received set of sequence of words, the steps of (a) identifying within the selected sequence of words, one or more strings, wherein the one or more strings are identified based on attributes of said strings, (b) identifying a class to which the identified one or more strings correspond, (c) generating a tokenized sequence of words based on the selected sequence of words, wherein the tokenized sequence of words is generated by substituting the identified one or more strings within the selected sequence of words with a corresponding class descriptor token, wherein each class descriptor token is associated with the class that has been identified for each such string, (d) generating a set of word embedding vector representations, wherein each word embedding vector representation within said set of word embedding vector representations corresponds to an individual word within the generated tokenized sequence of words, (e) generating a neural network corresponding to the tokenized sequence of words, wherein a final hidden state of the generated neural network comprises a vector representation of the tokenized sequence of words, and (f) recording an association between the selected sequence of words and one or both of the generated neural network or the vector representation of the tokenized sequence of words comprising the hidden state of the generated neural network.

At least one of the identified strings may comprise an entity name or entity identifier, and in which case, the identified class corresponding to said string may comprise an entity type associated with the entity name or entity identifier. At least one of the identified strings may describe a concept, and in which case the identified class corresponding to said string may comprise a concept class associated with the described concept. At least one of the identified strings may comprise a keyword, wherein the identified class corresponding to said string may comprise a keyword class associated with the keyword.

The method may further comprise the steps of (i) retrieving the generated neural network that corresponds to the tokenized sequence of words, (ii) receiving an additional sequence of words for training the retrieved neural network, (iii) identifying within the additional sequence of words, one or more additional strings, wherein the one or more additional strings are identified based on attributes of said additional strings, (iv) identifying an additional class corresponding to each identified additional string within the additional sequence of words, (v) generating an additional tokenized sequence of words based on the additional sequence of words, wherein the additional tokenized sequence of words is generated by substituting the identified one or more additional strings within the additional sequence of words with corresponding additional class descriptor tokens that are associated with an additional class that has been identified for such additional string, (vi) generating an additional set of word embedding vector representations, wherein each word embedding vector representation within said additional set of word embedding vector representations corresponds to an individual word within the generated additional tokenized sequence of words, (vii) retraining the retrieved neural network by processing the additional set of word embedding vector representations through the retrieved neural network, such that a final hidden state of the retrained neural network comprises a vector representation of the additional tokenized sequence of words, (viii) receiving an assessment of relevance of the additional sequence of words in comparison with the selected sequence of words corresponding to the final hidden state of the retrieved neural network (ix) generating a new neural network by modifying node weights within the retrieved neural network based on the received assessment of relevance, and (x) recording an association between the new neural network and the selected sequence of words that has been previously associated with the retrieved neural network.

In an embodiment of the method, at least one of the identified additional strings comprises an entity name or entity identifier, and in which case the identified additional class corresponding to said additional string comprises an entity type associated with the entity name or entity identifier. In another embodiment, at least one of the identified additional strings describes a concept, and in which case the identified additional class corresponding to said additional string comprises a concept class associated with the described concept. In yet another embodiment of the method, at least one of the identified additional strings comprises a keyword, and in which case the identified additional class corresponding to said additional string comprises a keyword class associated with the keyword.

An embodiment of the method may further comprise the steps of (i) receiving a search query from a remote terminal, the search query comprising text data, (ii) tokenizing the search query by (a) identifying within the search query, one or more search query sub-strings, wherein the one or more search query sub-strings are identified based on attributes of said sub-string, (b) identifying a search query sub-string class corresponding to each identified search query sub-string, (c) substituting within said search query, identified search query sub-strings with corresponding identified search query sub-string classes, (d) generating a set of search query word embedding vector representations, wherein each search query word embedding vector representation within said set of search query word embedding vector representations corresponds to an individual word within the generated tokenized search query, (e) generating a search query neural network corresponding to the tokenized search query, wherein a final hidden state of the generated search query neural network comprises a vector representation of the tokenized search query, (f) comparing the search query neural network with one or more previously generated neural networks, wherein said one or more previously generated neural networks have been generated based on tokenized sequences of words corresponding to sequences of words extracted from documents or text that is stored within a search database, (g) determining based on the comparison of the search query neural network with the one or more previously generated neural networks, whether the search query neural network is similar or identical to any of the one or more previously generated neural networks, and (h) responsive to identifying a previously generated neural network that is similar or identical to the search query neural network (1) retrieving from the database, a document or text data record associated with the identified similar or matching previously generated neural network, and (2) transmitting the retrieved document or text data record to the remote terminal.

In a particular method embodiment, at least one of the identified search query sub-strings comprises an entity name or entity identifier, and in which case the identified search query sub-string class corresponding to said search query sub-string comprises an entity type associated with the entity name or entity identifier. In another embodiment, at least one of the identified search query sub-strings describes a concept, and in which case the identified search query sub-string class corresponding to said search query sub-string comprises a concept class associated with the described concept. In yet another embodiment, at least one of the identified search query sub-strings comprises a keyword, and in which case the identified search query sub-string class corresponding to said search query sub-string comprises a keyword class associated with the keyword.

In a specific method embodiment, the step of selecting the one or more previously generated neural networks for comparison, comprises (i) extracting from the database, a set of documents or text data records, wherein each extracted document or text data record includes one or more strings that match an identified search query sub-string within the received search query, and (ii) selecting, as the previously generated neural networks for comparison, one or more neural networks that are associated with the extracted set of documents or text data records.

In one method embodiment, the one or more strings identified within the selected sequence of words are entity names or entity identifiers that are identified based on one or more named-entity-recognition techniques.

In another method embodiment, the one or more of the class descriptor tokens within the tokenized sequence of words are not identical to words or phrases that occur in the language of the received text data.

In a particular embodiment of the method, each word embedding vector representation comprises a vector representing a word and its context within an input sequence of words.

In implementing the method each generated neural network may comprise any of a recursive neural network, a long-short-term-memory (LSTM) neural network, a bi-directional LSTM neural network, or a gated recursive unit neural network.

The invention additionally provides a system for implementing neural network based optimization of database search functionality. The system comprises a processor implemented server configured for (i) receiving text data comprising a set of sequences of words, wherein one or more sequences of words within the received text data is intended to be added to a searchable database. (ii) implementing, for each of the one or more selected sequences of words within the received set of sequence of words, the steps of (a) identifying within the selected sequence of words, one or more strings, wherein the one or more strings are identified based on attributes of said strings, (b) identifying a class to which the identified one or more strings correspond, (c) generating a tokenized sequence of words based on the selected sequence of words, wherein the tokenized sequence of words is generated by substituting the identified one or more strings within the selected sequence of words with a corresponding class descriptor token, wherein each class descriptor token is are associated with the class that has been identified for each such string, (d) generating a set of word embedding vector representations, wherein each word embedding vector representation within said set of word embedding vector representations corresponds to an individual word within the generated tokenized sequence of words, (e) generating a neural network corresponding to the tokenized sequence of words, wherein a final hidden state of the generated neural network comprises a vector representation of the tokenized sequence of words, and (f) recording an association between the selected sequence of words and one or both of the generated neural network or the vector representation of the tokenized sequence of words comprising the hidden state of the generated neural network.

In an embodiment of the system the server may be configured such that (i) at least one of the identified strings comprises an entity name or entity identifier, and wherein the identified class corresponding to said string comprises an entity type associated with the entity name or entity identifier, or (ii) at least one of the identified strings describes a concept, and wherein the identified class corresponding to said string comprises a concept class associated with the described concept, or (iii) at least one of the identified strings comprises a keyword, and wherein the identified class corresponding to said string comprises a keyword class associated with the keyword.

The server may further be configured for (i) retrieving the generated neural network that corresponds to the tokenized sequence of words, (ii) receiving an additional sequence of words for training the retrieved neural network, (iii) identifying within the additional sequence of words, one or more additional strings, wherein the one or more additional strings are identified based on attributes of said additional strings, (iv) identifying an additional class corresponding to each identified additional string within the additional sequence of words, (v) generating an additional tokenized sequence of words based on the additional sequence of words, wherein the additional tokenized sequence of words is generated by substituting the identified one or more additional strings within the additional sequence of words with corresponding additional class descriptor tokens that are associated with an additional class that has been identified for such additional string, (vi) generating an additional set of word embedding vector representations, wherein each word embedding vector representation within said additional set of word embedding vector representations corresponds to an individual word within the generated additional tokenized sequence of words, (vii) retraining the retrieved neural network by processing the additional set of word embedding vector representations through the retrieved neural network, such that a final hidden state of the retrained neural network comprises a vector representation of the additional tokenized sequence of words, (viii) receiving an assessment of relevance of the additional sequence of words in comparison with the selected sequence of words corresponding to the final hidden state of the retrieved neural network, (ix) generating a new neural network by modifying node weights within the retrieved neural network based on the received assessment of relevance, and (x) recording an association between the new neural network and the selected sequence of words that has been previously associated with the retrieved neural network.

In another embodiment, the server is configured such that (i) at least one of the identified additional strings comprises an entity name or entity identifier, and wherein the identified additional class corresponding to said additional string comprises an entity type associated with the entity name or entity identifier, or (ii) at least one of the identified additional strings describes a concept, and wherein the identified additional class corresponding to said additional string comprises a concept class associated with the described concept, or (iii) at least one of the identified additional strings comprises a keyword, and wherein the identified additional class corresponding to said additional string comprises a keyword class associated with the keyword.

The server may be further configured for (i) receiving a search query from a remote terminal, the search query comprising text data, (ii) tokenizing the search query by (a) identifying within the search query, one or more search query sub-strings, wherein the one or more search query sub-strings are identified based on attributes of said sub-string, (b) identifying a search query sub-string class corresponding to each identified search query sub-string, (c) substituting within said search query, identified search query sub-strings with corresponding identified search query sub-string classes, (d) generating a set of search query word embedding vector representations, wherein each search query word embedding vector representation within said set of search query word embedding vector representations corresponds to an individual word within the generated tokenized search query, (e) generating a search query neural network corresponding to the tokenized search query, wherein a final hidden state of the generated search query neural network comprises a vector representation of the tokenized search query, (f) comparing the search query neural network with one or more previously generated neural networks, wherein said one or more previously generated neural networks have been generated based on tokenized sequences of words corresponding to sequences of words extracted from documents or text that is stored within a search database, (g) determining based on the comparison of the search query neural network with the one or more previously generated neural networks, whether the search query neural network is similar or identical to any of the one or more previously generated neural networks, and (h) responsive to identifying a previously generated neural network that is similar or identical to the search query neural network (i) retrieving from the database, a document or text data record associated with the identified similar or matching previously generated neural network, and (ii) transmitting the retrieved document or text data record to the remote terminal.

In a more particular embodiment, the server may be configured such that (i) at least one of the identified search query sub-strings comprises an entity name or entity identifier, and wherein the identified search query sub-string class corresponding to said search query sub-string comprises an entity type associated with the entity name or entity identifier, or (ii) at least one of the identified search query sub-strings describes a concept, and wherein the identified search query sub-string class corresponding to said search query sub-string comprises a concept class associated with the described concept, or (iii) at least one of the identified search query sub-strings comprises a keyword, and wherein the identified search query sub-string class corresponding to said search query sub-string comprises a keyword class associated with the keyword.

In another embodiment, the server may be configured for selecting the one or more previously generated neural networks for comparison from among a set of previously generated neural networks stored within the database. Selecting the one or more previously generated neural networks comprises (i) extracting from the database, a set of documents or text data records, wherein each extracted document or text data record includes one or more strings that match an identified search query sub-string within the received search query, and (ii) selecting, as the previously generated neural networks for comparison, one or more neural networks that are associated with the extracted set of documents or text data records.

In another embodiment, the server may be configured such that the one or more strings identified within the selected sequence of words are entity names or entity identifiers that are identified based on one or more named-entity-recognition techniques.

In a specific embodiment of the system, the server may be configured such that one or more of the class descriptor tokens within the tokenized sequence of words are not identical to words or phrases that occur in the language of the received text data.

In another embodiment of the system, the server may be configured such that each word embedding vector representation comprises a vector representing a word and its context within an input sequence of words.

The server may for the purposes of the present invention be configured such that each generated neural network is any of a recursive neural network, a long-short-term-memory (LSTM) neural network, a bi-directional LSTM neural network, or a gated recursive unit neural network.

The invention further provides a computer program product for implementing neural network based optimization of database search functionality. The computer program product comprises a non-transitory computer usable medium having a computer readable program code embodied therein. The computer readable program code comprising instructions for (i) receiving text data comprising a set of sequences of words, wherein one or more sequences of words within the received text data is intended to be added to a searchable database, (ii) implementing, for each of the one or more selected sequences of words within the received set of sequence of words, the steps of (a) identifying within the selected sequence of words, one or more strings, wherein the one or more strings are identified based on attributes of said strings, (b) identifying a class to which the identified one or more strings correspond, (c) generating a tokenized sequence of words based on the selected sequence of words, wherein the tokenized sequence of words is generated by substituting the identified one or more strings within the selected sequence of words with a corresponding class descriptor token, wherein each class descriptor token is associated with the class that has been identified for each such string, (d) generating a set of word embedding vector representations, wherein each word embedding vector representation within said set of word embedding vector representations corresponds to an individual word within the generated tokenized sequence of words, (e) generating a neural network corresponding to the tokenized sequence of words, wherein a final hidden state of the generated neural network comprises a vector representation of the tokenized sequence of words, and (f) recording an association between the selected sequence of words and one or both of the generated neural network or the vector representation of the tokenized sequence of words comprising the hidden state of the generated neural network.

### BRIEF DESCRIPTION OF THE ACCOMPANYING DRAWINGS

FIG. 1 illustrates a method for generating context specific word vectors corresponding to one or more input sequences of words.

FIG. 2 illustrates a method for generating a neural network based representation of an input sequence of words.

FIG. 3 illustrates a method for generating a neural network based tokenized representation of an input sequence of words for future search and/or natural language understanding based matching purposes.

FIG. 4 illustrates another method for generating neural network based tokenized representations of input sequences of words for future search and/or natural language understanding based matching purposes.

FIG. 5 illustrates a method for using neural network based tokenized representations of concepts generated in accordance with the present invention, for the purposes of identifying data, text or documents relevant to received natural language inputs or terms extracted from received user input/search term(s).

FIG. 6 illustrates another method of using one or more databases and/or data model service(s) that are based on or involve neural network based tokenized representations of concepts generated in accordance with the present invention, to identify documents/concepts/text that are relevant to received user inputs/search queries/terms extracted therefrom.

FIG. 7 illustrates an exemplary server configured to implement one or more of the methods of the present invention.

FIG. 8 illustrates an exemplary system that may be used to implement part or whole of the present invention.

### DETAILED DESCRIPTION

The invention provides novel methods, systems and computer program products for optimizing matching functionality in natural language understanding systems through implementation of word embedding and neural networks.

For the purposes of the present description and accompanying claims, references to a “set” of any item(s) or object(s) shall be understood to refer to a set comprising either one or more than one of such item(s) or object(s).

For the purposes of the present description and accompanying claims, references to ‘string’ or ‘strings’ shall be understood to refer to any of text strings, numeric strings, alphanumeric strings, character strings, strings including special characters, any array of text, numeric, character based or other data in any language or notation, or any combination thereof.

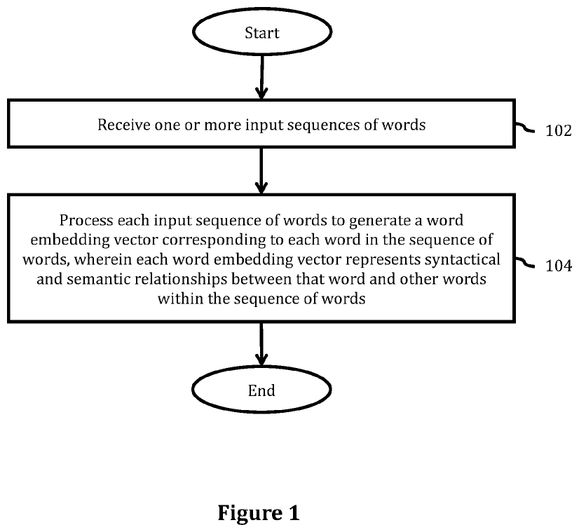

FIG. 1 illustrates a method for generating context specific word vectors corresponding to one or more input sequences of words. The method of FIG. 1 is a method of neural word embedding, that receives one or more sentences and generates a vector representation of individual words in the received sentence(s).

Step 102 of FIG. 1 comprises receiving one or more input sequences of words (e.g. one or more sentences)—which input sequences of words are intended to be processed using a neural word embedding method for generating vector representations of the individual words therein.

Thereafter, at step 104, each of the sequences of words is processed to generate a word embedding vector corresponding to each word in the sequence of words—wherein each word embedding vector represents syntactical and semantic relationships between that word and other words in the sentence. Step 104 may comprise implementation of one or more word vector generating algorithms or processes, including any one of word2vec, GloVE, FastText, Bag of Words, StarSpace (see https://www.aaai.org/ocs/index.php/AAAI/AAAI18/paper/viewFile/l6998/16114), Elmo (see https://allennlp.org/elmo) and BERT (see https://github.com/google-research/bert), or any other word embedding algorithm or process that would be apparent to the skilled person. For each word in the received sentence(s), the output of step 104 is a vector representing the word and its context within the input sequence of words.

It would be understood that the method of FIG. 1 can be applied to words within a single sentence, a paragraph, a document, or an entire set of documents. It would be further understood that in an embodiment of the invention the processing applied in step 104 could include typical well-known pre-processing techniques including methods such as, but not only, (i) converting all characters to same case text, (ii) encoding using tokenization, (iii) translations via maps, (iv) removing stop words, and/or (v) stemming or lemmatization to normalize a sequence of words by replacing one or more words in the sequence with a dictionary form or root form of the word that conveys the basic meaning of the word without conveying inflections (e.g. plurals, different tenses) within the original word.

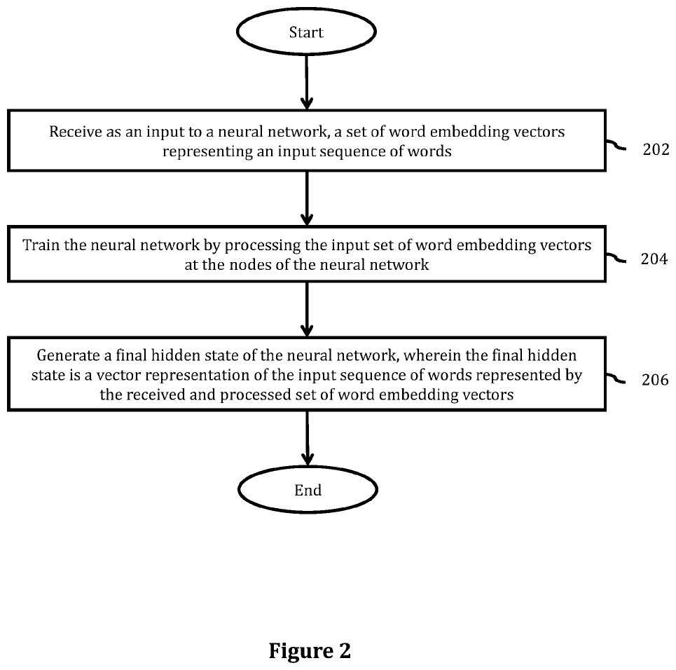

FIG. 2 illustrates a method for generating a neural network based representation of an input sequence of words. The method of FIG. 2 is configured to generate the neural network based representation of the input sequence of words based on word embedding vectors that have been generated in respect of individual words within the input sequence of words (for example, based on the method of FIG. 1).

Step 202 comprises receiving as an input to a neural network, a set of word embedding vectors that represent an input sequence of words/input sentence (for example, a set of word embedding vectors that have been generated in respect of an input sequence of words/input sentence in accordance with the method of FIG. 1).

Step 204 comprises training the neural network by processing the input set of word embedding vectors at the node(s) of the neural network.

Thereafter, step 206 comprises generating a final hidden state of the neural network, wherein the final hidden state comprises a vector representation of the input sequence of words/input sentence that is represented by the set of word embedding vectors that have been used as inputs to train the neural network.

As discussed in more detail below, the vector representation of the input sequence of words that is generated at step 206 may be stored in a search database, and may subsequently be compared against vector representations of input sequences of words that form received user inputs/search queries/terms extracted therefrom—such that similarities between the compared vector representations would indicate that the vectorized representation of words stored in the search database is a match for the input sequences of words that form received user inputs/search queries/terms extracted therefrom.

The neural network of FIG. 2 may comprise any form of neural network that is appropriate for the objective of generating a vector representation of input sequences of words. It would be understood that the implemented neural network could have several architectural variations that include the addition of memory elements or external service that allows past inputs to be considered (and which are grouped under the general class of Recursive Neural Networks). In various embodiments, the recursive neural network comprises any of a long-short-term-memory (LSTM) network (either applied in normal word order, or applied in reverse word order which has the effect of taking future words in a sentence to provide context that resolves an ambiguity that arises when reading words in the normal word order), a bi-directional LSTM network (which combines forward and reverse approaches, by blending weights from both approaches), or a Gated Recursive Unit (GRU) network (which is a modification of an LSTM neural network that reduces the amount of computation involved for substantially similar levels of classification accuracy) or any other type of neural network that would be apparent to the skilled person for achieving the objectives of the method of FIG. 2.

The method of FIG. 2 can be applied to a single sequence of words/sentence, or to each sequence of words/sentence within a paragraph, within an entire document, or within an entire set of documents. The method may also be applied to one or more specific sequences of words/sentences that have been selected or identified within a paragraph, document or documents.

It would be understood that the method of generating vector representations of sequences of words/sentences may be selectively applied to specific assertion type sentences or validation type sentences within a body of text to generate vector representations corresponding to such assertion type sentences or validation type sentences—which vector representations can be used for the purposes of identifying documents that match input sequences of words that form future received user inputs/search queries/terms extracted therefrom, involving identical or syntactically or conceptually similar assertions or validations.

In certain embodiments, the method of FIG. 2 for generating vector representations of sequences of words/sentences may be applied to sequences of words/sentences to which one or more well-known pre-processing techniques including methods such as, but not only, (i) converting all characters to same case text, (ii) encoding using tokenization, (iii) translations via maps, (iv) removing stop words, and/or (v) stemming or lemmatization to normalize a sequence of words by replacing one or more words in the sequence with a dictionary form or root form of the word that conveys the basic meaning of the word without conveying inflections (e.g. plurals, different tenses) within the original word.

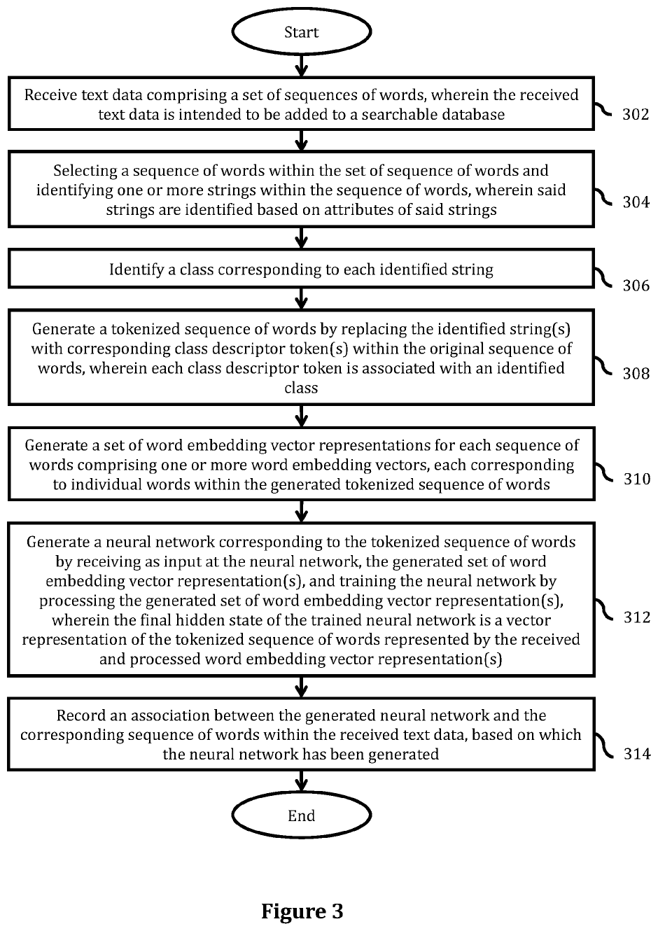

FIG. 3 illustrates a method for generating a neural network based tokenized representation of an input sequence of words for future natural language understanding based matching purposes. The method of FIG. 3 is premised on the principal that generating vector representations of sequences of words (for example, sentences) which include entity names, (a name for a person, place or thing or an alias for the same thing e.g. Apple Computer, Apple Inc. the Apple Watch, Steve Jobs) or any other specific entity identities (any type of descriptor that serves to identify a specific entity for example, a numerical or alphanumerical identifier, a government issued identification number, or a descriptive sentence or phrase that identifies a particular entity or that indicates, suggests or implies [with reasonable certainty] a particular entity), or for that matter a specific concept or a specific keyword, results in generated vector representations that are partly or wholly characterized by the entity names or entity identities or concept or keyword. For the purposes of this disclosure the term ‘entity name’ and ‘entity identity’ should be read as being inclusive of the set of things normally detected by Named Entity Recognition (NER) systems that includes people, places, organisations, numbers, times etc. and also more general classification that can be tokenised that include concepts (abstractions of terms, logical groupings or ideas that can be defined for similar or related things but not necessarily including entities known to the system, e.g. relationships in concept, marketplaces, industries, product types and services), keywords (a word or phrase [i.e. a sequence of words] that are identified as relevant to the system for analysis e.g. ‘market leader’, ‘best of breed’) Accordingly, such vector representations of assertions or validations that are generated in accordance with the method of FIG. 2 may result in vector representations that may be conceptually, syntactically and/or semantically very similar to a future query or user input, but which may erroneously be determined or judged as having a low (or lower) matching relevance to the future search query in case the search query does not include the entity names or entity identities or specific concepts or specific keywords that have been included within the generated vector representation of the assertion or validation.

The method of FIG. 3 seeks to address this problem by generating for the purposes of natural language understanding of future received user inputs/search queries/terms extracted therefrom, tokenized vector representations of input sequences of words/sentences, wherein the tokenized vector representations preserve conceptual, syntactical and/or semantical information from within the input sequences of words/input sentences, while omitting strings within the input sequences of words/sentences that represent specific classes of data such as entity names or entity identities or specific concepts or specific keywords that would otherwise serve to limit the generality of the assertion or validation contained within the input sequence(s) of words/sentences.

Step 302 of FIG. 3 comprises receiving text data comprising a set of sequences of words or a set of sentences, wherein one or more sequences of words or sentences within the received text data is intended to be added to a searchable database. The text data may comprise one or more sentences, a paragraph, or an entire document.

Step 304 comprises selecting a sequence of words or a sentence within the set of sequence of words or sentences received at step 302, and identifying within the selected sequence of words, one or more strings (which term may be understood in accordance with the explanations provided hereinabove) within the selected sequence of words/sentence. The one or more strings may be identified based on attributes of said strings. In an embodiment, the one or more strings may comprise any of entity names or entity identifiers, concepts or keywords—and may be identified at step 304 based on a determination that said string represents an entity name, entity identifier, concept or keyword. The determination that a string represents an entity name, entity identifier, concept or keyword may be based on parsing and analysis of content and/or any other attributes of said string in an embodiment where the identified string comprises an entity name or entity identifier, said string may be identified at step 304 based on one or more named-entity-recognition techniques that would be apparent to the skilled person. In an embodiment, the named-entity-recognition may be implemented using a neural network based system or engine that has been trained using marked up data that identifies word types such as verb, adjective, pronoun, noun etc., and which further sub-classifies identified nouns with additional tags or identifiers such as Organization, Person, Place etc. The resulting trained neural network is then able to use sentence structure to classify words and phrases in sentences as potential entities (organization, person, place etc.), or concepts or keywords, without a priori knowledge of the word/term. For the purposes of the present invention the terms “entity names” or “entity identifiers” shall be understood as referring to names or identifiers that denote or represent specific instances of entity types. For example, in the sentence, “Apple and Samsung enter into non-compete agreement in the mobile phone space”, the terms “Apple” or “Samsung” are entity names that denote specific instances of companies (which comprises an entity type), whereas the phrase ‘mobile phone space” is a specific instance of a concept known as a marketspace.

Step 306 comprises identifying a class corresponding to each identified string (e.g. which string represents an entity name, entity identifier, concept or keyword) within the selected sequence of words/sentence. A class corresponding to an identified string may in an embodiment be detected based on one or more named-entity-recognition techniques that would be apparent to the skilled person. For the purposes of the present invention the term “class” shall be understood as referring to a descriptor that denotes or represents a category or sub-category of entities, concepts or keywords. For example, “person”, “male”, “female” and “company” are each an instance of a category or sub-category type that would be understood as an class for the purpose of the present invention. In the above discussed example of the sentence “Apple and Samsung enter into non-compete agreement in the mobile phone space”, the class corresponding to each of the identified entity names “Apple” or “Samsung”, would be the class “company” and the identified concept “mobile phone space” would have a corresponding class “concept_marketspace”.

In an embodiment of step 306, in the event an identified string is determined to comprise an entity name or entity identifier, the class corresponding to said string may comprise an entity type associated with the entity name or entity identifier. In the event an identified string is determined to comprise a concept, the class corresponding to said string may comprise a concept class associated with the entity name or entity identifier. In the event an identified string is determined to comprise a keyword, the class corresponding to said string may comprise a keyword class associated with the keyword. Any additional classification of string or strings beyond entities, concepts or keywords, would be applied in the same way.

Step 308 comprises generating a tokenized sequence of words based on the sequence of words/sentence selected at step 304—wherein the tokenized sequence of words is generated by replacing the identified strings (that have been identified within the selected sequence of words at step 304), with a class descriptor token that is associated with their corresponding class(es) that have been identified at step 306. So for example, in the sentence of the input sequence of words “Apple and Samsung enter into non-compete agreement in the mobile phone space”, the tokenized sequence of words generated at step 308 would be “_COMPANY_and_COMPANY_enter into non-compete agreement in the _CONCEPT_MARKETSPACE_”. It would be noted that in particular embodiments of the invention, the class descriptor token “_COMPANY_” is deliberately chosen (for example, instead of “Company”) to ensure that the replacing term does not clash with words that would be found in naturally occurring untokenized word sequences (i.e. are not identical to or are dissimilar to words or phrases that occur in the language of the relevant document/text) A further refinement of this step is possible when highly accurate Named Entity Recognition is available to use additional context via enumerated tokens “_COMPANY1_and_COMPANY2 enter into non-compete agreement in the mobile phone space” or subclassified class descriptor (or sub-class descriptor) tokens that encapsulate additional features such as the subject and object of a sentence: “_COMPANY_SUBJECT_and_COMPANY_OBJECT_ enter into non-compete agreement in _CONCEPT_MARKETSPACE_”

In an embodiment of the invention the processing applied in step 308 may be preceded or succeeded by one or more pre-processing techniques such as but not limited to, (i) converting all characters to same case text, (ii) encoding using tokenization, (iii) translations via maps, (iv) removing stop words, and/or (v) stemming or lemmatization to normalize a sequence of words by replacing one or more words in the sequence with a dictionary form or root form of the word that conveys the basic meaning of the word without conveying inflections (e.g plurals, different tenses) within the original word. It would however be understood that each of the above pre-processing techniques is entirely different from step 308—for the reason that none of these pre-processing techniques involves substituting a word or string with a class descriptor token that represents a class or class-type associated with such word or string.

Step 310 comprises generating a set of word embedding vector representations for each sequence of words, said set of word embedding vector representations comprising one or more word embedding vectors, wherein each word embedding vector corresponds to an individual word within the tokenized sequence of words generated at step 308. In an embodiment, the word embedding vectors within the set of word embedding vector representation of step 310 are generated based on a method in accordance with the teachings of FIG. 1.

Step 312 thereafter comprises generating a neural network corresponding to the tokenized sequence of words generated at step 308, wherein generating the neural network comprises receiving as input at a neural network, the set of word embedding vector representations generated at step 310, and training said neural network by processing the set of word embedding vector representations such that the final hidden state of the trained neural network is a vector representation of the tokenized sequence of words (generated at step 308) as represented by the received and processed set of word embedding vector representations (as generated at step 310). In an embodiment, the neural network of step 312 (or the vector representation of the tokenized sequence of words that comprises the final hidden state of the trained neural network) is generated based on a method in accordance with the teachings of FIG. 2.

Step 314 comprises recording an association between (i) either the generated neural network (generated at step 312) or the vector representation of the tokenized sequence of words comprising the final hidden state of the trained neural network, and (ii) the corresponding sequence of words or sentence that has been selected at step 304 (and based on which the neural network has been generated at step 312).

The objective of recording the association at step 314 is that, in the event the vector representation of the tokenized sequence of words generated at step 312 is found to match a future search query, the corresponding sequence of words or sentence that is associated therewith (or a document or body of text data within the sequence of words or sentence is contained) may be identified, retrieved and presented or displayed as a search result.

In an embodiment of the method of FIG. 3, multiple iterations of steps 302 to 314 may be executed—wherein each iteration is in respect of a different sequence of words or a different sentence within a body of text such as a paragraph, page or document. Each iteration results in output of a distinct tokenized sequence of words/tokenized sentence, and a corresponding distinct neural network or vector representation of said tokenized sequence of words/tokenized sentence. The generated plurality of neural networks or vector representations of said tokenized sequence of words/tokenized sentence comprises an ensemble/set of neural networks or vector representations correspond to (or represent) the conceptual content of a sentence within the body of text.

In an embodiment of the invention, the invention may additionally implement one or more clustering algorithms to detect a plurality of documents or text data records such that one or more neural networks or vector representations corresponding to tokenized sequences of words/tokenized sentences (that have been generated in accordance with the methods of FIG. 3) within each of said plurality of documents or text data records, satisfy one or more predefined similarity criteria in comparison with each other. By implementing such clustering algorithms, the invention enables identification and clustering of documents or data records that are conceptually/contextually and/or semantically similar to each other.

By implementing the method of FIG. 3, the invention enables generation of neural networks that can be configured to be selectively insensitive or agnostic to particular attributes of text data or sequences of words (such as for example, text case i.e upper/lower case, language variations etc., temporal changes etc.), which do not have a significant impact on contextual or semantic meaning of the text data or sequence of words—and which as explained in further detail below, enables identification of search results based on contextual or semantic similarity to an input search query.

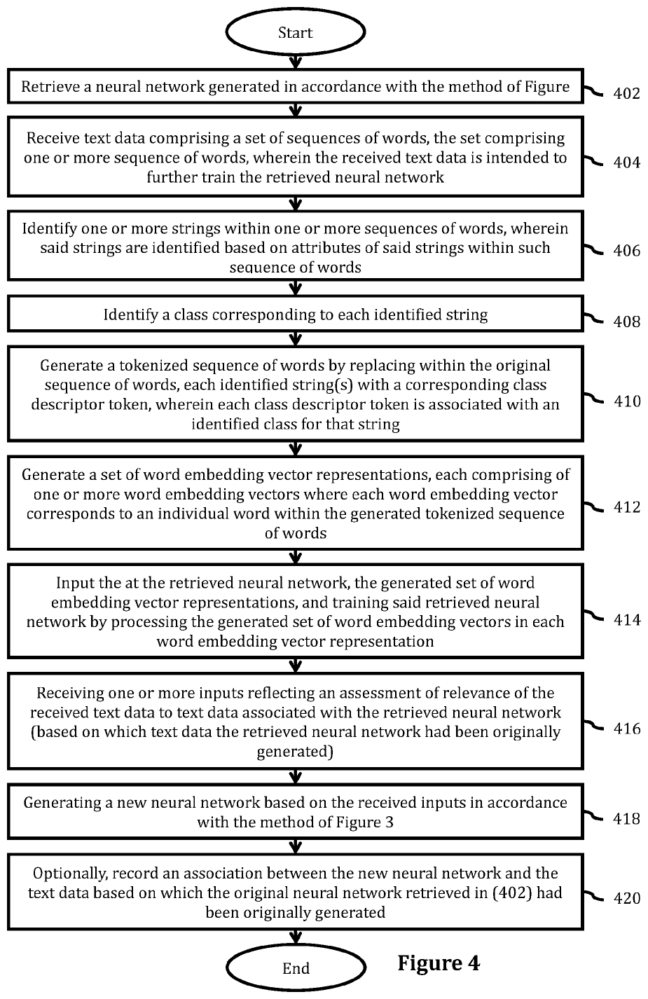

FIG. 4 illustrates another method for generating neural network based tokenized representations of input sequences of words for future search purposes and/or natural language understanding based matching purposes. In particular, the method of FIG. 4 is a method for influencing, modifying or optimizing neural networks that have been generated (for search purposes) in accordance with the method of FIG. 3—based on an external assessment of relevance of search results that are generated based on such neural network(s).

Step 402 comprises retrieving a neural network that has been generated in accordance with the method of FIG. 3 (for example, a neural network generated at step 312 of FIG. 3). The neural network retrieved at step 402 may be retrieved based on input identifying (i) the neural network that is to be retrieved or (ii) a vector representation of a tokenized sequence of words/tokenized sentence that has been used to generate the neural network or (iii) a tokenized sequence of words/tokenized sentence that has been used to generate the neural network or (iv) a sequence of words or a sentence that was subsequently tokenized and used for the purposes of generating the neural network.

Step 404 comprises receiving text data comprising a set of sequences of words, said set comprising one or more sequences of words (for example receiving a body of text, paragraph, page or document), wherein the received text data is intended to further train the neural network received at step 404.

Step 406 comprises identifying within one or more of said sequences of words, one or more strings (which term may be understood in accordance with the explanations provided hereinabove) within said sequence(s) of words. The one or more strings may be identified based on attributes of said strings. In an embodiment, the one or more strings may comprise any of entity names or entity identifiers, concepts or keywords and may be identified at step 406 based on a determination that said string represents an entity name, entity identifier, concept or keyword. The determination that a string represents an entity name, entity identifier, concept or keyword may be based on parsing and analysis of content and/or any other attributes of said string. In an embodiment where the identified string comprises an entity name or entity identifier, said string may be identified at step 406 based on one or more named-entity-recognition techniques. Step 408, comprises identifying a class corresponding to each identified string (e.g. which string represents an entity name, entity identifier, concept or keyword) within the sequence(s) of words. As in the case of the method of FIG. 3, in an embodiment one or both of steps 406 and 408 may rely on named-entity-recognition techniques for the purposes of identifying entity names/entity identifiers and corresponding entity types and/or entity type tokens associated with said entity types.

In an embodiment of step 408, in the event an identified string is determined to comprise an entity name or entity identifier, the class corresponding to said string may comprise an entity type associated with the entity name or entity identifier. In the event an identified string is determined to comprise a concept, the class corresponding to said string may comprise a concept class associated with the entity name or entity identifier. In the event an identified string is determined to comprise a keyword, the class corresponding to said string may comprise a keyword class associated with the keyword.

Step 410 thereafter comprises generating a tokenized sequence of words based on the sequence of words within which strings have been identified—wherein the tokenized sequence of words is generated by replacing the identified strings (that have been detected within the selected sequence of words at step 406), with a class descriptor token that is associated with their corresponding class(es) that have been identified at step 408.

In an embodiment of the invention the processing applied in step 410 could be preceded or succeeded by one or more pre-processing techniques such as but not limited to, (i) converting all characters to same case text, (ii) encoding using tokenization, (iii) translations via maps, (iv) removing stop words, and/or (v) stemming or lemmatization to normalize a sequence of words by replacing one or more words in the sequence with a dictionary form or root form of the word that conveys the basic meaning of the word without conveying inflections (e.g plurals, different tenses) within the original word. It would however be understood that each of the above pre-processing techniques is entirely different from step 410—for the reason that none of these pre-processing techniques involves substituting a word or string with a class descriptor token that represents a class or class-type associated with such word or string.

Step 412 comprises generating a set of word embedding vector representations, each word embedding vector representation comprising one or more word embedding vectors, wherein each word embedding vector in the word embedding vector representation corresponds to an individual word within the tokenized sequence of words generated at step 410. In an embodiment, the word embedding vectors of step 412 are generated based on a method in accordance with the teachings of FIG. 1. In a further embodiment, the set of word embedding vector representations is generated based on a method in accordance with the teachings of FIG. 3, wherein entity names within an input sequence of words to which a word embedding vector representation corresponds, have been substituted with entity type tokens.

Step 414 thereafter involves providing as input to the neural network retrieved at step 402, the generated set of word embedding vector representations (generated at step 412) corresponding to individual words within the generated tokenized sequence of words (generated at step 410) and training said neural network (that has been retrieved at step 402) by processing the input set of word embedding vectors within each word embedding vector representation—such that the final hidden state of the trained neural network is a vector representation of the tokenized sequence of words (generated at step 410) as represented by the received and processed set of word embedding vector representations (as generated at step 412). In an embodiment, the trained neural network resulting at step 414 (or the vector representation of the tokenized sequence of words that comprises the final hidden state of said trained neural network) is generated based on a method in accordance with the teachings of FIG. 2.

Step 416 thereafter comprises receiving one or more inputs representing an assessment of relevance of the received text data (received at step 404) or any one or more sequences of words within said received text data in respect of (or in comparison with) the text data or the sequence of words that have been associated with the neural network retrieved at step 402 (i.e. the text data/sequence of words that have been associated with said neural network at step 314 of FIG. 3). In various embodiments, the assessment of relevance may comprise an assessment of relevance received from one or more users, or alternatively may comprise a machine based or algorithm based or a neural network based assessment of relevance. The assessment of relevance may be received in any number of different forms that would be apparent to the user, including without limitation an absolute score, a relative score, a relevance band, text-based comments, or any other form of assessment. In particular embodiments, the assessment of relevance may comprise any of:
ratings feedback from users on which content on the same topic/concept makes a stronger case for relevance than other content
tagged data that is associated with a particular point of view/topic/concept
output of tagging from a user or an automated detector (e.g. a machine based or algorithm based or a neural network based detector), which indicates the presence of a topic/concept that is either similar or dissimilar to the validation or assertion represented by the retrieved neural network. In an embodiment, the tagging may be received from an external service that is configured to store, process or proffer such capabilities, and in a more particular embodiment, could be received from an externally located second neural network that is distinct from a first neural network that is referred to above in connection with one or more of steps 402 to 416 and which second neural network is configured to provide processing capabilities and support that is different from the processing capabilities provided by the first neural network.

At step 418, a new neural network is generated to capture a wider representation of matching concepts from the neural network retrieved at step 402 by applying the training process described in FIG. 3 to the assessed text data or sequences of words from step 416 in which the node weights of the new neural network are determined responsive to the assessment of relevance of the sequences of words in step 416 satisfying one or more predefined relevance thresholds.

Step 420 comprises recording an association between the new neural network that is generated as an output of step 418 and the text data or the sequence of words that have been associated with the neural network retrieved at step 402 (i.e. the text data/sequence of words that have been associated with said neural network at step 314 of FIG. 3).

It would be understood that as a result of implementing the method steps of FIG. 4, a neural network that has been generated as being representative of a particular concept/topic/assertion/validation may be modified or skewed for further accuracy (i.e. for better representing the particular concept/topic/assertion/validation) based on assessments of relevance that are generated in the course of the above described method.

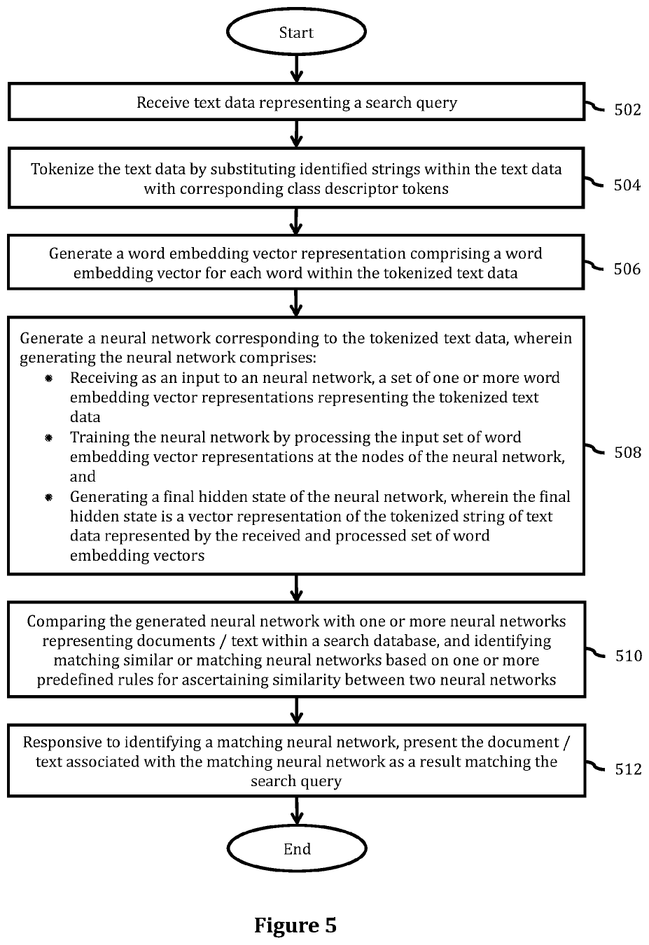

FIG. 5 illustrates a method for using neural network based tokenized representations of concepts generated in accordance with the present invention, for the purposes of identifying data, text or documents relevant to received natural language inputs or terms extracted from received user input/search term(s).

Step 502 of FIG. 5 comprises receiving text data comprising a string or sequence of words or a sentence, representing a search query (i.e representing for which a search requires to be carried out in a database of text records). The received text data may comprise one or more sentences, a paragraph, or an entire document. The received text data may be received from a remote terminal.

Step 504 comprises tokenizing the text data received at step 502 by replacing strings that have been identified based on their string attributes (for example, entity names, entity identifiers, concepts or keywords) within the text data with corresponding identified class descriptor tokens. As in the case of FIGS. 3 and 4, in certain embodiments, entity names, entity identifiers, concepts or keywords may be identified and corresponding classes and/or class descriptor tokens may be determined based on parsing and analysis of content and/or any other attributes of said string. In an embodiment where the identified string(s) comprises an entity name or entity identifier, identification and classification of the entity name or entity identifier and may be based on implementation of named-entity recognition methods that would be apparent to the skilled person.

In an embodiment of the invention the processing applied in step 504 may be preceded or succeeded by one or more pre-processing techniques such as but not limited to, (i) converting all characters to same case text, (ii) encoding using tokenization, (iii) translations via maps, (iv) removing stop words, and/or (v) stemming or lemmatization to normalize a sequence of words by replacing one or more words in the sequence with a dictionary form or root form of the word that conveys the basic meaning of the word without conveying inflections (e.g plurals, different tenses) within the original word. It would however be understood that each of the above pre-processing techniques is entirely different from step 504—for the reason that none of these pre-processing techniques involves substituting a word or string with a class descriptor token that represents a class or class-type associated with such word or string.

Step 506 comprises generating one or more word embedding vector representation(s) wherein each word embedding vector in a word embedding vector representation corresponds to an individual word within the tokenized sequence of words generated at step 504. In an embodiment, the word embedding vectors of step 506 are generated based on a method in accordance with the teachings of FIG. 1 and the word embedding vector representation(s) is generated in accordance with the methods of FIG. 3.

Step 508 thereafter comprises generating a neural network corresponding to the tokenized sequence of words generated at step 506, wherein generating the neural network comprises (i) receiving as input at a neural network, the one or more word embedding vector representations generated at step 506, (ii) training said neural network by processing the generated set of word embedding vector representations—such that the final hidden state of the trained neural network is a vector representation of the tokenized text data (generated at step 504) as represented by the received and processed set of word embedding vector representations (as generated at step 506). In an embodiment, the neural network of step 508 (or the vector representation of the tokenized sequence of words that comprises the final hidden state of the trained neural network) is generated based on a method in accordance with the teachings of FIG. 2.

Step 510 comprises comparing the neural network generated at step 508 with one or more neural networks representing documents/text within a search database and identifying similar or neural networks based on one or more predefined rules for ascertaining similarity between two neural networks. In an embodiment, the comparison of step 510 may comprise comparing the final hidden state of the neural network generated at step 508 against the final hidden state of one or more neural networks representing documents/text within a search database, and identifying matching similar or matching neural networks based on identification of final hidden based on one or more predefined matching algorithms (for example, based on an algorithm ascertaining whether the difference between the two final hidden states falls within a defined threshold or range or is less than a defined maximum permissible difference using a comparison function, such as cosine distance). In a specific embodiment, the one or more neural networks representing documents/text within a database are neural networks that have been generated according to the methods of FIG. 3 or 4 (i.e. based on tokenized text data wherein identified strings (for example, strings representing entity names, entity identifiers, concepts or keywords) within sequences of words or sentences have been replaced with corresponding class descriptor tokens prior to generation of such neural network corresponding to said sequence of words or sentences).

At step 512, responsive to identifying a similar or matching neural network representing documents/text within a search database, the method comprises retrieving from a database, the document/text associated with the identified similar or matching neural network and presenting the retrieved document/text as a result best matching received user inputs/search queries/terms extracted therefrom in an embodiment, the retrieved document/text may be transmitted to a remote terminal from which the search query has been received, for display as a search result or as a search result of relevance. In an embodiment of the invention, a determination whether two neural networks are similar or matching may be based on one or more predefined similarity criteria—for example a defined maximum threshold value of difference.

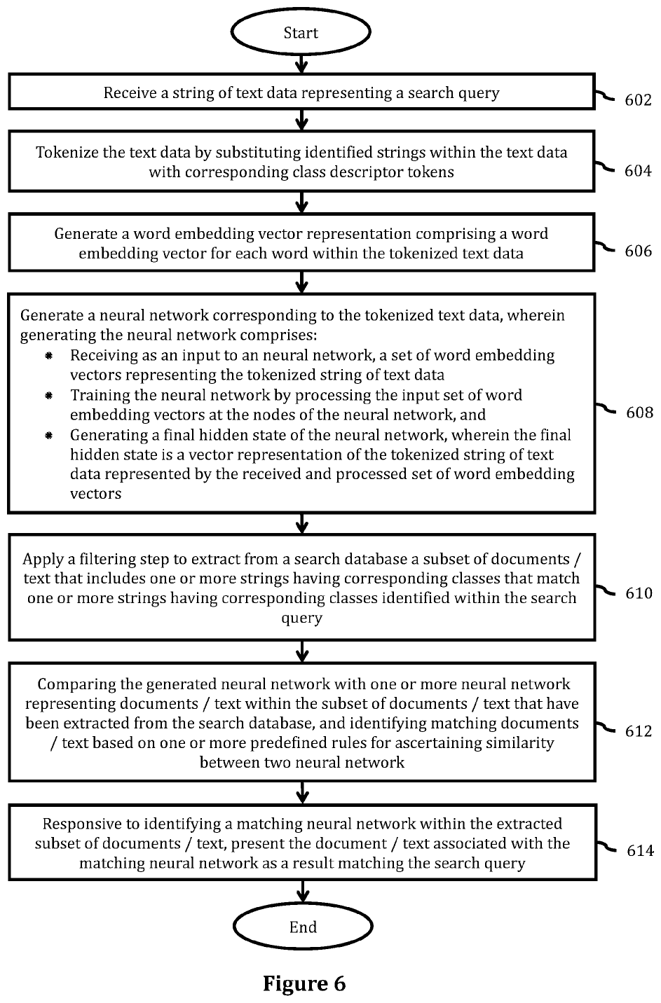

FIG. 6 illustrates another method of using one or more databases and/or data model service(s) that are based on or involve neural network based tokenized representations of concepts generated in accordance with the present invention, to identify documents/text that are relevant to received user inputs/search queries/terms extracted therefrom.

Step 602 of FIG. 6 comprises receiving text data comprising a string or sequence of words or a sentence, representing a user input or search term(s)—for example a search query representing information for which a search requires to be carried out in a database of text records. The received text data may comprise one or more sentences, a paragraph, or an entire document.

Step 604 comprises tokenizing the text data received at step 602 by replacing strings that have been identified based on their string attributes (for example, entity names, entity identifiers, concepts or keywords) within the text data with corresponding identified class descriptor tokens. As in the case of FIGS. 3 to 5, in certain embodiments, entity names, entity identifiers, concepts or keywords may be identified and corresponding classes and/or class descriptor tokens may be determined based on parsing and analysis of content and/or any other attributes of said string. In an embodiment where the identified string(s) comprises an entity name or entity identifier, identification and classification of the entity name or entity identifier and may be based on implementation of named-entity recognition methods that would be apparent to the skilled person.

In an embodiment of the invention the processing applied in step 604 may be preceded or succeeded by one or more pre-processing techniques such as but not limited to, (i) converting all characters to same case text, (ii) encoding using tokenization, (iii) translations via maps, (iv) removing stop words, and/or (v) stemming or lemmatization to normalize a sequence of words by replacing one or more words in the sequence with a dictionary form or root form of the word that conveys the basic meaning of the word without conveying inflections (e.g. plurals, different tenses) within the original word. It would however be understood that each of the above pre-processing techniques is entirely different from step 604—for the reason that none of these pre-processing techniques involves substituting a word or string with a class descriptor token that represents a class or class-type associated with such word or string.

Step 606 comprises generating a set of word embedding vector representations, each word embedding vector representation comprising word embedding vectors corresponding to individual words within the tokenized sequence of words generated at step 604. In an embodiment, the word embedding vectors of step 606 are generated based on a method in accordance with the teachings of FIG. 1 and the word embedding vector representations are generated in accordance with the teachings of FIG. 3.

Step 608 thereafter comprises generating a neural network corresponding to the tokenized sequence of words generated at step 606, wherein generating the neural network comprises (i) receiving as input at a neural network, the set of word embedding vector representations generated at step 606, (ii) training said neural network by processing the generated set of word embedding vector representations—such that the final hidden state of the trained neural network is a vector representation of the tokenized text data (generated at step 604) as represented by the received and processed set of word embedding vector representations (as generated at step 606). In an embodiment, the neural network of step 608 (or the vector representation of the tokenized sequence of words that comprises the final hidden state of the trained neural network) is generated based on a method in accordance with the teachings of FIG. 2.

Step 610 comprises applying a filtering step (or a pre-processing step), wherein said filtering step retrieves or extracts from a database, a subset of documents or text data records that includes one or more strings having corresponding classes (for example strings that represent entity names, entity identifiers, concepts or keywords) which match the one or more strings and their corresponding classes that have been identified within the search query for the purposes of the tokenization of step 604. It would be understood that for the purposes of the method of FIG. 6, the search query from which strings are extracted for the purposes of the filtering step at step 610 may be generated based on received user inputs or may be generated based on one or more outputs from a computer/machine implemented system or neural network that is configured to output one or more potential entities for which a search requires to be implemented. In a preferred embodiment, said filtering step retrieves or extracts from a search database, a subset of documents or text data records that includes one or more strings which match the one or more strings identified within the received user inputs/search queries/terms extracted therefrom for the purposes of the tokenization of step 604 and which additionally are of the same class (e.g. entity name, entity identifier, concept or keyword) as the strings within the search query.

Step 612 comprises comparing the neural network generated at step 608 with one or more neural networks representing (i.e. that are associated with) documents/text data records that form the subset of documents or text data records that has been retrieved or extracted through the filtering step described in step 610, and identifying similar or neural networks based on one or more predefined rules, methods or algorithms for ascertaining similarity between two neural networks such as but not limited to cosine distance. In an embodiment, the comparison of step 610 may comprise comparing the final hidden state of the neural network generated at step 608 against the final hidden state of one or more neural networks representing documents/text data records that form the subset of documents or text data records that has been retrieved or extracted through the filtering step described in step 610, and identifying matching similar or matching neural networks based on identification of final hidden based on one or more predefined matching algorithms (for example, based on an algorithm ascertaining whether the difference between the two final hidden states falls within a defined threshold or range or is less than a defined maximum permissible difference). In a specific embodiment, the one or more neural networks representing documents/text data records within a search database are neural networks that have been generated according to the methods of FIG. 3 or 4 (i.e. based on tokenized text data wherein identified strings within sequences of words or sentences have been replaced with corresponding class descriptor tokens prior to generation of such neural network corresponding to said sequence of words or sentences).

At step 614, responsive to identifying a similar or matching neural network representing documents/text data records within a search database, the method comprises retrieving from a database, the document/text data records associated with the identified similar or matching neural network and presenting the retrieved document/text data records as a result matching the received user inputs/search queries/terms extracted therefrom.

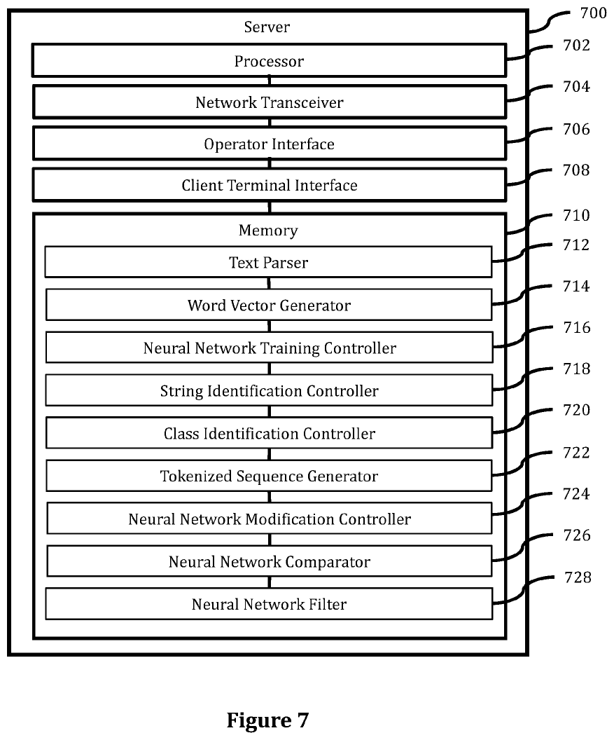

FIG. 7 illustrates an exemplary server 700 configured to implement one or more of the methods of the present invention.

Server 700 comprises a processor 702 configured to implement one or more data processing operations, a network transceiver 704 configured to enable server 700 to receive and transmit data over one or more communication networks, an operator interface 706 configured to enable a system operator to access and/or configure server 700, a client terminal interface 708 configured to provide an interface through which one or more search queries from client terminals can be received and responded to, and a memory 710.

Memory 710 may include one or both of transitory memory and non-transitory memory. Additionally memory 710 may include therewithin, one or more of a processor implemented text parser 712, a processor implemented word vector generator 714, a processor implemented neural network training controller 716, a processor implemented string identification controller 718, a processor implemented class identification controller 720, a processor implemented tokenized sequence generator 722, a processor implemented neural network modification controller 724, a processor implemented neural network comparator 726, and a processor implemented neural network filter 728.

The processor implemented text parser 712 within memory 710 may be configured to parse individual words and/or sequences of words from within text data received as input at server 700.

The processor implemented word vector generator 714 within memory 710 may be configured to generate context specific word vectors corresponding to one or more input sequences of words (for example, in accordance with the method of FIG. 1 described above).

The processor implemented neural network training controller 716 within memory 710 may be configured to generate or train a neural network based on a received representation of an input sequence of words—wherein the received representation of the input sequence of words may comprise word embedding vectors that have been generated by word vector generator 714 in respect of individual words within the input sequence of words. In an embodiment, the neural network training controller 716 may be configured to implement the method of FIG. 2 of the present invention or the method of FIG. 3 of the present invention.

The processor implemented named string identification controller 718 may be configured to identify within an input sequence of words, one or more strings based on attributes of such one or more strings. In an embodiment string identification controller 718 may be configured to identify strings that represent entity names, or specific entity identities (i.e. any type of descriptor that serves to identify a specific entity—for example, a numerical or alphanumerical identifier, a government issued identification number, or a descriptive sentence or phrase that identifies a particular entity or that indicates, suggests or implies [with reasonable certainty] a particular entity), concepts or keywords. In an embodiment, string identification controller 718 may be configured to implement method step 304 of FIG. 3 as described above.

The processor implemented class identification controller 720 may be configured to identify a class corresponding to each identified string (identified by string identification controller 718) within a selected sequence of words/sentences. In a particular embodiment, class identification controller 720 may be configured to implement method step 306 of FIG. 3 as described above.

The processor implemented tokenized sequence generator 722 may be configured to generate a tokenized sequence of words based on a received sequence of words or a sentence—wherein the tokenized sequence of words is generated by replacing each identified string (identified by string identification controller 718) within the selected sequence of words, with a corresponding class descriptor token that is associated with the corresponding identified class (that has been identified by class identification controller 720). In a particular embodiment, tokenized sequence generator 722 may be configured to implement method step 308 of FIG. 3 as described above.

The processor implemented neural network modification controller 724 is configured to modify or optimize neural networks that have been generated by neural network training controller 716 based on external assessments of relevance of search results that are generated through such neural networks. In a particular embodiment, neural network modification controller 724 is configured to implement the method steps of FIG. 4 as described above.

The processor implemented neural network comparator 726 is configured to use neural network based tokenized representations of concepts that are generated by server 700 for the purposes of identifying data, text or documents relevant to received natural language inputs or terms extracted from received user input/search term(s). In an embodiment, neural network comparator 726 is configured to implement the method steps of FIG. 5 or FIG. 6 as described above.

The processor implemented neural network filter 728 is configured to retrieve or extracts from a database, a subset of documents or text data that includes one or more strings which match one or more strings identified within a search query for the purposes of the tokenization of step 604. In an embodiment, neural network filter 728 is configured to implement method step 610 of FIG. 6 as described above.

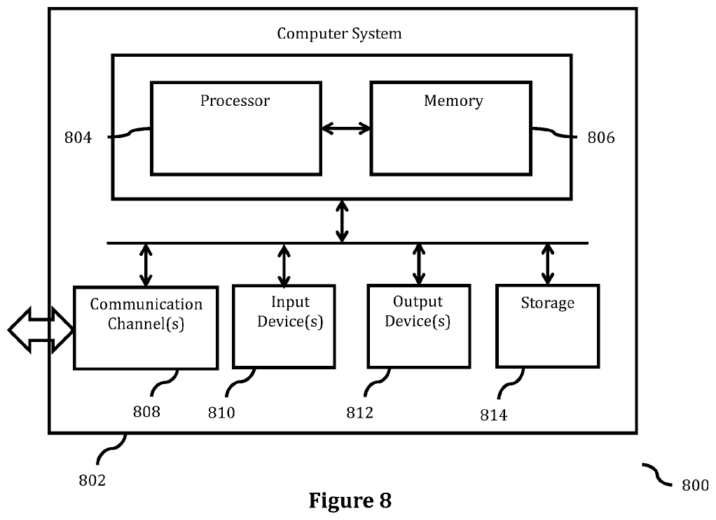

FIG. 8 illustrates an exemplary system 800 that may be used to implement part or whole of the present invention.

The illustrated system 800 comprises a computer system 802 which in turn includes one or more processors 804 and at least one memory 806. Processor 804 is configured to execute program instructions—and may be a real processor or a virtual processor. It will be understood that computer system 802 does not suggest any limitation as to scope of use or functionality of described embodiments. The computer system 802 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 802 in accordance with the present invention may include one or more servers, desktops, laptops, tablets, smart phones, mobile phones, mobile communication devices, tablets, phablets and personal digital assistants. In an embodiment of the present invention, the memory 806 may store software for implementing various embodiments of the present invention. The computer system 802 may have additional components. For example, the computer system 802 may include one or more communication channels 808, one or more input devices 810, one or more output devices 812, and storage 814. An interconnection mechanism (not shown) such as a bus, controller, or network, interconnects the components of the computer system 802. In various embodiments of the present invention, operating system software (not shown) provides an operating environment for various software's executing in the computer system 802 using a processor 804, and manages different functionalities of the components of the computer system 802.

The communication channel(s) 808 allow communication over a communication medium to various other computing entities. The communication medium provides information such as program instructions, or other data in a communication media. The communication media includes, but is not limited to, wired or wireless methodologies implemented with an electrical, optical. RF, infrared, acoustic, microwave, Bluetooth or other transmission media.

The input device(s) 810 may include, but is not limited to, a touch screen, a keyboard, mouse, pen, joystick, trackball, a voice device, a scanning device, or any another device that is capable of providing input to the computer system 802. In an embodiment of the present invention, the input device(s) 810 may be a sound card or similar device that accepts audio input in analog or digital form. The output device(s) 812 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 802.

The storage 814 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 802. In various embodiments of the present invention, the storage 814 may contain program instructions for implementing any of the described embodiments.

In an embodiment of the present invention, the computer system 802 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 802. The method described herein is typically implemented as a computer program product, comprising a set of program instructions that is executed by the computer system 802 or any other similar device. The set of program instructions may be a series of computer readable codes stored on a tangible medium, such as a computer readable storage medium (storage 814), for example, diskette, CD-ROM, ROM, flash drives or hard disk, or transmittable to the computer system 802, via a modem or other interface device, over either a tangible medium, including but not limited to optical or analogue communications channel(s) 808. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the teachings of the methods of FIGS. 3, 5 and 6 discussed above, it is apparent that one of the critical features of the invention is the implementation of tokenisation to replace entity names with entity type tokens in training data for generating neural networks.

Previous solutions did not incorporate this approach, and at best would involve the step of adding entity type or word type ‘tag data’ to an entity name within the training data. While adding such entity type or word type tag data has shown some effectiveness in increasing the signal to noise ratio when training the neural network, it does not in any way reduce the overall symbol count in the training data (and in fact increases the overall symbol count within the training data)—since the training data still contains both the entity name as well as the added entity type tag. As a result, the process of training neural networks using prior art solutions (which do not replace entity names with entity type tokens)
creates a generalized neural network for predicting all symbols that does not differential between named entities and the concepts that link the named entities
as a result, the prior art methods of adding an entity type tag to an entity name only result in a small improvement in computational efficiency for training neural networks

In contrast, generating and using training data where entity names are substituted with entity type tokens, results in several significant advances in search capabilities as well as computational efficiencies, for the reasons that
the substitution of entity names with entity type tokens reduces the overall symbol count—which consequently reduces the amount of data required for training each neural network, as well as a reduces the number of training iterations necessary for the neural network to converge (i.e. to be deemed sufficiently trained)
the resulting neural networks that have been trained in accordance with the teachings of the present invention are independent of specific entity names and hence can be trained using data from one industry/set of companies/people and then applied to another industry/set of companies/people without additional training. This has been found to differ significantly from existing transfer learning methods, where general neural networks have to be trained with a wide corpus of data, and thereafter have to be provided further data to re-train the weights for new situations (e.g. new entity names)
the entity independent nature of the neural networks of the present invention effectively boosts the signal in relation to concepts that link entities within the training data, and has been found to result in increased accuracy of the neural network for classify and/or matching the content of documents presented to the network
by implementing the methods of FIG. 3, 5 or 6, the invention enables generation of neural networks that can be configured to be selectively insensitive or agnostic to particular attributes of text data or sequences of words (such as for example, text case i.e upper/lower case, language variations etc., temporal changes etc.), which do not have a significant impact on contextual or semantic meaning of the text data or sequence of words—and which instead enables identification of search results of relevance by identifying search results based on contextual or semantic similarity to an input search query.
as a result of all of the above, the present invention provides several advantages over prior art solutions, including
   time savings as a result of having to perform fewer training runs to tune the neural network
   power savings as a result of a reduction in the amount of computing power and/or resources required to train the network
   increased classification accuracy in the outputs of the neural network, and
   a decrease in the need for domain-specific data for initial training.
   the ability to immediately reuse an existing neural network in a different or previously unknown domain to perform initial classifications without first retraining the neural network with domain-specific data

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment specifically contemplated, is intended to be practiced in the absence of any element which is not specifically disclosed herein.

What is claimed is:

1. A method for implementing neural network based optimization of database search functionality, the method comprising the steps of:
receiving text data comprising a set of sequences of words, wherein one or more sequences of words within the received text data is intended to be added to a searchable database;
implementing, for each of the one or more selected sequences of words within the received set of sequence of words, the steps of:
identifying within the selected sequence of words, one or more strings, wherein the one or more strings are identified based on attributes of said strings;
identifying a class to which the identified one or more strings correspond;
generating a tokenized sequence of words based on the selected sequence of words, wherein the tokenized sequence of words is generated by substituting the identified one or more strings within the selected sequence of words with a corresponding class descriptor token, wherein each class descriptor token is associated with the class that has been identified for each such string;
generating a set of word embedding vector representations, wherein each word embedding vector representation within said set of word embedding vector representations corresponds to an individual word within the generated tokenized sequence of words;
generating a neural network corresponding to the tokenized sequence of words, wherein a final hidden state of the generated neural network comprises a vector representation of the tokenized sequence of words; and
recording an association between the selected sequence of words and one or both of the generated neural network or the vector representation of the tokenized sequence of words comprising the hidden state of the generated neural network.

2. The method as claimed in claim 1, wherein:
at least one of the identified strings comprises an entity name or entity identifier, and wherein the identified class corresponding to said string comprises an entity type associated with the entity name or entity identifier; or
at least one of the identified strings describes a concept, and wherein the identified class corresponding to said string comprises a concept class associated with the described concept; or
at least one of the identified strings comprises a keyword, and wherein the identified class corresponding to said string comprises a keyword class associated with the keyword.

3. The method as claimed in claim 1, further comprising the steps of:
retrieving the generated neural network that corresponds to the tokenized sequence of words;
receiving an additional sequence of words for training the retrieved neural network;
identifying within the additional sequence of words, one or more additional strings, wherein the one or more additional strings are identified based on attributes of said additional strings;
identifying an additional class corresponding to each identified additional string within the additional sequence of words;
generating an additional tokenized sequence of words based on the additional sequence of words, wherein the additional tokenized sequence of words is generated by substituting the identified one or more additional strings within the additional sequence of words with corresponding additional class descriptor tokens that are associated with an additional class that has been identified for such additional string;
generating an additional set of word embedding vector representations, wherein each word embedding vector representation within said additional set of word embedding vector representations corresponds to an individual word within the generated additional tokenized sequence of words;
retraining the retrieved neural network by processing the additional set of word embedding vector representations through the retrieved neural network, such that a final hidden state of the retrained neural network comprises a vector representation of the additional tokenized sequence of words;
receiving an assessment of relevance of the additional sequence of words in comparison with the selected sequence of words corresponding to the final hidden state of the retrieved neural network;
generating a new neural network by modifying node weights within the retrieved neural network based on the received assessment of relevance; and
recording an association between the new neural network and the selected sequence of words that has been previously associated with the retrieved neural network.

4. The method as claimed in claim 3, wherein:
at least one of the identified additional strings comprises an entity name or entity identifier, and wherein the identified additional class corresponding to said additional string comprises an entity type associated with the entity name or entity identifier; or
at least one of the identified additional strings describes a concept, and wherein the identified additional class corresponding to said additional string comprises a concept class associated with the described concept; or
at least one of the identified additional strings comprises a keyword, and wherein the identified additional class corresponding to said additional string comprises a keyword class associated with the keyword.

5. The method as claimed in claim 1, further comprising:
receiving a search query from a remote terminal, the search query comprising text data;
tokenizing the search query by:
identifying within the search query, one or more search query sub-strings, wherein the one or more search query sub-strings are identified based on attributes of said sub-string;
identifying a search query sub-string class corresponding to each identified search query sub-string;
substituting within said search query, identified search query sub-strings with corresponding identified search query sub-string classes;
generating a set of search query word embedding vector representations, wherein each search query word embedding vector representation within said set of search query word embedding vector representations corresponds to an individual word within the generated tokenized search query;
generating a search query neural network corresponding to the tokenized search query, wherein a final hidden state of the generated search query neural network comprises a vector representation of the tokenized search query;
comparing the search query neural network with one or more previously generated neural networks, wherein said one or more previously generated neural networks have been generated based on tokenized sequences of words corresponding to sequences of words extracted from documents or text that is stored within a search database;
determining based on the comparison of the search query neural network with the one or more previously generated neural networks, whether the search query neural network is similar or identical to any of the one or more previously generated neural networks; and
responsive to identifying a previously generated neural network that is similar or identical to the search query neural network:
retrieving from the database, a document or text data record associated with the identified similar or matching previously generated neural network; and
transmitting the retrieved document or text data record to the remote terminal.

6. The method as claimed in claim 5, wherein:
at least one of the identified search query sub-strings comprises an entity name or entity identifier, and wherein the identified search query sub-string class corresponding to said search query sub-string comprises an entity type associated with the entity name or entity identifier; or
at least one of the identified search query sub-strings describes a concept, and wherein the identified search query sub-string class corresponding to said search query sub-string comprises a concept class associated with the described concept; or
at least one of the identified search query sub-strings comprises a keyword, and wherein the identified search query sub-string class corresponding to said search query sub-string comprises a keyword class associated with the keyword.

7. The method as claimed in claim 5, wherein the one or more previously generated neural networks are selected for comparison, said selection for comparison comprising:
extracting from the database, a set of documents or text data records, wherein each extracted document or text data record includes one or more strings that match an identified search query sub-string within the received search query; and
selecting, as the previously generated neural networks for comparison, one or more neural networks that are associated with the extracted set of documents or text data records.

8. The method as claimed in claim 1, wherein the one or more strings identified within the selected sequence of words are entity names or entity identifiers that are identified based on one or more named-entity-recognition techniques.

9. The method as claimed in claim 1, wherein the one or more of the class descriptor tokens within the tokenized sequence of words are not identical to words or phrases that occur in the language of the received text data.

10. The method as claimed in claim 1, wherein each word embedding vector representation comprises a vector representing a word and its context within an input sequence of words.

11. The method as claimed in claim 1, wherein each generated neural network is any of a recursive neural network, a long-short-term-memory (LSTM) neural network, a bi-directional LSTM neural network, or a gated recursive unit neural network.

12. A system for implementing neural network based optimization of database search functionality, the system comprising a processor implemented server configured for:
receiving text data comprising a set of sequences of words, wherein one or more sequences of words within the received text data is intended to be added to a searchable database;
implementing, for each of the one or more selected sequences of words within the received set of sequence of words, the steps of:
identifying within the selected sequence of words, one or more strings, wherein the one or more strings are identified based on attributes of said strings;
identifying a class to which the identified one or more strings correspond;
generating a tokenized sequence of words based on the selected sequence of words, wherein the tokenized sequence of words is generated by substituting the identified one or more strings within the selected sequence of words with a corresponding class descriptor token, wherein each class descriptor token is are associated with the class that has been identified for each such string;
generating a set of word embedding vector representations, wherein each word embedding vector representation within said set of word embedding vector representations corresponds to an individual word within the generated tokenized sequence of words;
generating a neural network corresponding to the tokenized sequence of words, wherein a final hidden state of the generated neural network comprises a vector representation of the tokenized sequence of words; and
recording an association between the selected sequence of words and one or both of the generated neural network or the vector representation of the tokenized sequence of words comprising the hidden state of the generated neural network.

13. The system as claimed in claim 12, wherein the server is configured such that:
at least one of the identified strings comprises an entity name or entity identifier, and wherein the identified class corresponding to said string comprises an entity type associated with the entity name or entity identifier; or
at least one of the identified strings describes a concept, and wherein the identified class corresponding to said string comprises a concept class associated with the described concept; or
at least one of the identified strings comprises a keyword, and wherein the identified class corresponding to said string comprises a keyword class associated with the keyword.

14. The system as claimed in claim 12, wherein the server is further configured for:
retrieving the generated neural network that corresponds to the tokenized sequence of words;
receiving an additional sequence of words for training the retrieved neural network;
identifying within the additional sequence of words, one or more additional strings, wherein the one or more additional strings are identified based on attributes of said additional strings;
identifying an additional class corresponding to each identified additional string within the additional sequence of words;
generating an additional tokenized sequence of words based on the additional sequence of words, wherein the additional tokenized sequence of words is generated by substituting the identified one or more additional strings within the additional sequence of words with corresponding additional class descriptor tokens that are associated with an additional class that has been identified for such additional string;
generating an additional set of word embedding vector representations, wherein each word embedding vector representation within said additional set of word embedding vector representations corresponds to an individual word within the generated additional tokenized sequence of words;
retraining the retrieved neural network by processing the additional set of word embedding vector representations through the retrieved neural network, such that a final hidden state of the retrained neural network comprises a vector representation of the additional tokenized sequence of words;
receiving an assessment of relevance of the additional sequence of words in comparison with the selected sequence of words corresponding to the final hidden state of the retrieved neural network;
generating a new neural network by modifying node weights within the retrieved neural network based on the received assessment of relevance; and
recording an association between the new neural network and the selected sequence of words that has been previously associated with the retrieved neural network.

15. The system as claimed in claim 14, wherein the server is configured such that:
at least one of the identified additional strings comprises an entity name or entity identifier, and wherein the identified additional class corresponding to said additional string comprises an entity type associated with the entity name or entity identifier; or
at least one of the identified additional strings describes a concept, and wherein the identified additional class corresponding to said additional string comprises a concept class associated with the described concept; or
at least one of the identified additional strings comprises a keyword, and wherein the identified additional class corresponding to said additional string comprises a keyword class associated with the keyword.

16. The system as claimed in claim 12, wherein the server is further configured for:
receiving a search query from a remote terminal, the search query comprising text data;
tokenizing the search query by:
identifying within the search query, one or more search query sub-strings, wherein the one or more search query sub-strings are identified based on attributes of said sub-string;
identifying a search query sub-string class corresponding to each identified search query sub-string;
substituting within said search query, identified search query sub-strings with corresponding identified search query sub-string classes;
generating a set of search query word embedding vector representations, wherein each search query word embedding vector representation within said set of search query word embedding vector representations corresponds to an individual word within the generated tokenized search query;
generating a search query neural network corresponding to the tokenized search query, wherein a final hidden state of the generated search query neural network comprises a vector representation of the tokenized search query;
comparing the search query neural network with one or more previously generated neural networks, wherein said one or more previously generated neural networks have been generated based on tokenized sequences of words corresponding to sequences of words extracted from documents or text that is stored within a search database;
determining based on the comparison of the search query neural network with the one or more previously generated neural networks, whether the search query neural network is similar or identical to any of the one or more previously generated neural networks; and
responsive to identifying a previously generated neural network that is similar or identical to the search query neural network:
retrieving from the database, a document or text data record associated with the identified similar or matching previously generated neural network; and
transmitting the retrieved document or text data record to the remote terminal.

17. The system as claimed in claim 16, wherein the server is configured such that:
at least one of the identified search query sub-strings comprises an entity name or entity identifier, and wherein the identified search query sub-string class corresponding to said search query sub-string comprises an entity type associated with the entity name or entity identifier; or
at least one of the identified search query sub-strings describes a concept, and wherein the identified search query sub-string class corresponding to said search query sub-string comprises a concept class associated with the described concept; or
at least one of the identified search query sub-strings comprises a keyword, and wherein the identified search query sub-string class corresponding to said search query sub-string comprises a keyword class associated with the keyword.

18. The system as claimed in claim 16, wherein the server is configured for selecting the one or more previously generated neural networks for comparison from among a set of previously generated neural networks stored within the database, and wherein selecting the one or more previously generated neural networks comprises:
extracting from the database, a set of documents or text data records, wherein each extracted document or text data record includes one or more strings that match an identified search query sub-string within the received search query; and
selecting, as the previously generated neural networks for comparison, one or more neural networks that are associated with the extracted set of documents or text data records.

19. The system as claimed in claim 12, wherein the server is configured such that the one or more strings identified within the selected sequence of words are entity names or entity identifiers that are identified based on one or more named-entity-recognition techniques.

20. The system as claimed in claim 12, wherein the server is configured such that one or more of the class descriptor tokens within the tokenized sequence of words are not identical to words or phrases that occur in the language of the received text data.

21. The system as claimed in claim 12, wherein the server is configured such that each word embedding vector representation comprises a vector representing a word and its context within an input sequence of words.

22. The system as claimed in claim 12, wherein the server is configured such that each generated neural network is any of a recursive neural network, a long-short-term-memory (LSTM) neural network, a bi-directional LSTM neural network, or a gated recursive unit neural network.

23. A computer program product for implementing neural network based optimization of database search functionality, the computer program product comprising a non-transitory computer usable medium having a computer readable program code embodied therein, the computer readable program code comprising instructions for:
receiving text data comprising a set of sequences of words, wherein one or more sequences of words within the received text data is intended to be added to a searchable database;
implementing, for each of the one or more selected sequences of words within the received set of sequence of words, the steps of:
identifying within the selected sequence of words, one or more strings, wherein the one or more strings are identified based on attributes of said strings;
identifying a class to which the identified one or more strings correspond;
generating a tokenized sequence of words based on the selected sequence of words, wherein the tokenized sequence of words is generated by substituting the identified one or more strings within the selected sequence of words with a corresponding class descriptor token, wherein each class descriptor token is associated with the class that has been identified for each such string;
generating a set of word embedding vector representations, wherein each word embedding vector representation within said set of word embedding vector representations corresponds to an individual word within the generated tokenized sequence of words;
generating a neural network corresponding to the tokenized sequence of words, wherein a final hidden state of the generated neural network comprises a vector representation of the tokenized sequence of words; and
recording an association between the selected sequence of words and one or both of the generated neural network or the vector representation of the tokenized sequence of words comprising the hidden state of the generated neural network.
